(19) United States
(12) Patent Application Publication
(10) Pub. No.: US 2006/0064558 A1
(43) Pub. Date: Mar. 23, 2006

(54) Internal mirroring operations in storage networks

(76) Inventors: Robert A. Cochran, Sacramento, CA (US); Titus E. Davis, Rocklin, CA (US)

Correspondence Address: HEWLETT PACKARD COMPANY, P O BOX 272400, 3404 E. HARMONY ROAD, INTELLECTUAL PROPERTY ADMINISTRATION, FORT COLLINS, CO, 80527-2400, US

(21) Appl. No.: 10/945,183

(22) Filed: Sep. 20, 2004

(51) Int. Cl. G06F 12/16

(52) U.S. Cl. 711/162; 711/113

(57) ABSTRACT

An exemplary storage network and methods of operation are disclosed which make use of data consistent internal mirrors within a storage device. The exemplary storage network comprises first, second, and third storage cells, each of which include physical storage media and a storage controller that controls data operations with the storage media. The storage controllers are configured such that, in operation, write operations executed on the first storage cell are copied remotely in an ordered sequence to a cache memory in the second storage cell, write operations in the cache memory are mirrored onto a primary and secondary storage media in the second storage cell, and write operations mirrored to the secondary storage media are copied remotely to the third storage cell.

### TECHNICAL FIELD

The described subject matter relates to electronic computing, and more particularly to systems and methods for managing storage in electronic computing systems.

### BACKGROUND

Effective collection, management, and control of information have become a central component of modern business processes. To this end, many businesses, both large and small, now implement computer-based information management systems.

Data management is an important component of a computer-based information management system. Many users implement storage networks to manage data operations in computer-based information management systems. Storage networks have evolved in computing power and complexity to provide highly reliable, managed storage solutions that may be distributed across a wide geographic area.

Data redundancy is one aspect of reliability in storage networks. A single copy of data is vulnerable if the network element on which the data resides fails. If the vulnerable data or the network element on which it resides can be recovered, then the loss may be temporary. However, if either the data or the network element cannot be recovered then the vulnerable data may be lost permanently.

Storage networks implement remote copy procedures to provide data redundancy and failover procedures to provide data consistency in the event of a failure of one or more network elements. Remote copy procedures replicate one or more data sets resident from a first storage site onto at least a second storage site, and frequently onto a third storage site. Adroit resource management is desirable to balance competing demands between reducing host response times and ensuring data consistency between multiple storage sites.

### SUMMARY

In an exemplary implementation a storage network is provided. The storage network comprises a first storage cell at a first location, the first storage cell including physical storage media and a storage controller that controls data transfer operations with the storage media; a second storage cell at a second location, the second storage cell including physical storage media and a storage controller that controls data transfer operations with the storage media; and a third storage cell at a third location, the third storage cell including physical storage media and a storage media controller that controls data transfer operations with the storage media. In operation, write operations executed on the first storage cell are copied remotely in an ordered sequence to a cache memory in the second storage cell; write operations in the cache memory are mirrored onto a primary and secondary storage media in the second storage cell; and write operations in the mirrored secondary storage media are copied remotely to the third storage cell.

### BRIEF DESCRIPTION OF THE DRAWINGS

FIG. 1 is a schematic illustration of an exemplary implementation of a networked computing system that utilizes a storage network.

FIG. 2 is a schematic illustration of an exemplary implementation of a storage network.

FIG. 3 is a schematic illustration of an exemplary implementation of a computing device that can be utilized to implement a host.

FIG. 4 is a schematic illustration of an exemplary implementation of a storage cell.

FIG. 5 is a flowchart illustrating operations in a first exemplary implementation for executing write operations in a storage network.

FIG. 6 is a flowchart illustrating operations in a second exemplary implementation for executing write operations in a storage network.

FIG. 7 is a flowchart illustrating operations in a third exemplary implementation for executing write operations in a storage network.

FIG. 8 is a flowchart illustrating operations in a fourth exemplary implementation for executing write operations in a storage network.

FIG. 9 is a schematic illustration of an exemplary implementation of a three-site data replication architecture.

### DETAILED DESCRIPTION

Described herein are exemplary storage network architectures and methods for performing internal mirroring operations in storage networks. The methods described herein may be embodied as logic instructions on a computer-readable medium such as, e.g., firmware executable on a processor. When executed on a processor, the logic instructions cause processor to be programmed as a special-purpose machine that implements the described methods.

Exemplary Network Architecture

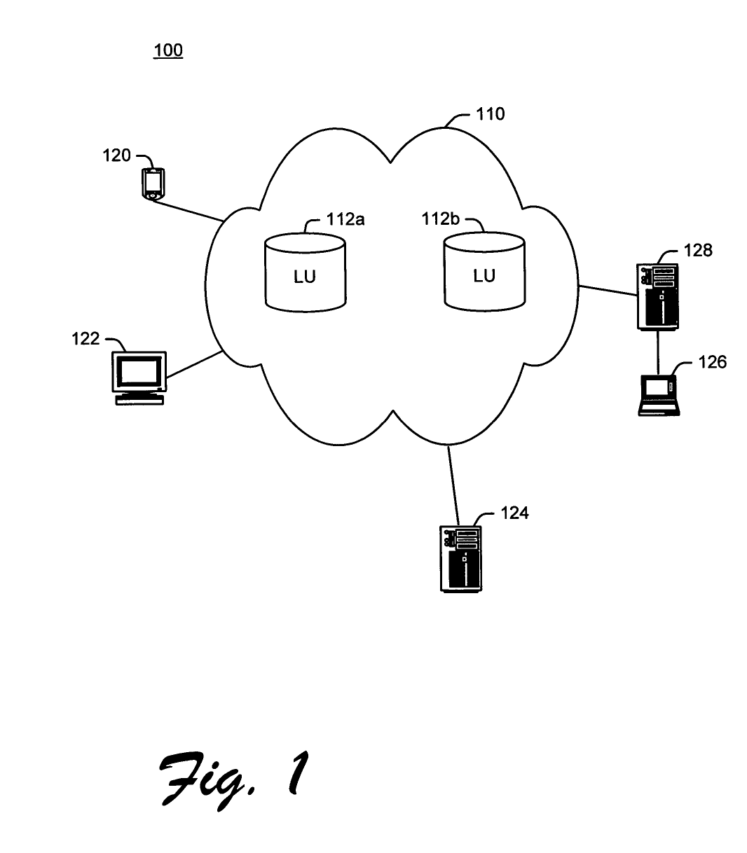

FIG. 1 is a schematic illustration of an exemplary implementation of a networked computing system 100 that utilizes a storage network. The storage network comprises a storage pool 110, which comprises an arbitrarily large quantity of storage space. In practice, a storage pool 110 has a finite size limit determined by the particular hardware used to implement the storage pool 110. However, there are few theoretical limits to the storage space available in a storage pool 110.

A plurality of logical disks (also called logical units or LUs) 112a, 112b may be allocated within storage pool 110. Each LU 112a, 112b comprises a contiguous range of logical addresses that can be addressed by host devices 120, 122, 124 and 128 by mapping requests from the connection protocol used by the host device to the uniquely identified LU 112. As used herein, the term “host” comprises a computing system(s) that utilize storage on its own behalf, or on behalf of systems coupled to the host. For example, a host may be a supercomputer processing large databases or a transaction processing server maintaining transaction records. Alternatively, a host may be a file server on a local area network (LAN) or wide area network (WAN) that provides storage services for an enterprise. A file server may comprise one or more disk controllers and/or RAID controllers configured to manage multiple disk drives. A host connects to a storage network via a communication connection such as, e.g., a Fibre Channel (FC) connection.

A host such as server 128 may provide services to other computing or data processing systems or devices. For example, client computer 126 may access storage pool 110 via a host such as server 128. Server 128 may provide file services to client 126, and may provide other services such as transaction processing services, email services, etc. Hence, client device 126 may or may not directly use the storage consumed by host 128.

Devices such as wireless device 120, and computers 122, 124, which are also hosts, may logically couple directly to LUs 112a, 112b. Hosts 120-128 may couple to multiple LUs 112a, 112b, and LUs 112a, 112b may be shared among multiple hosts. Each of the devices shown in FIG. 1 may include memory, mass storage, and a degree of data processing capability sufficient to manage a network connection.

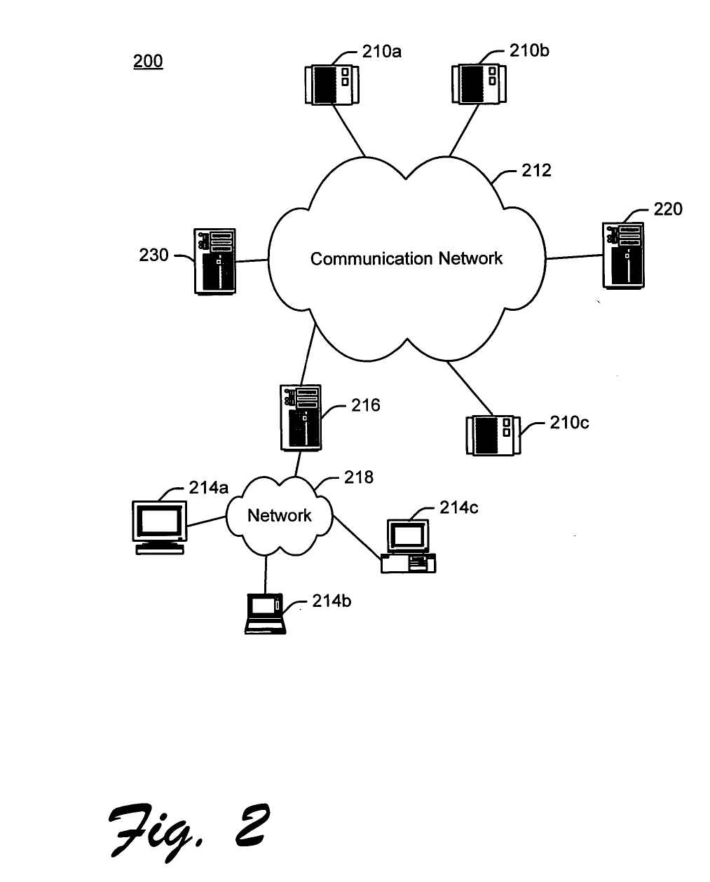

FIG. 2 is a schematic illustration of an exemplary storage network 200 that may be used to implement a storage pool such as storage pool 110. Storage network 200 comprises a plurality of storage cells 210a, 210b, 210c connected by a communication network 212. Storage cells 210a, 210b, 210c may be implemented as one or more communicatively connected storage devices. Exemplary storage devices include the STORAGEWORKS line of storage devices commercially available from Hewlett-Packard Corporation of Palo Alto, Calif., USA. Communication network 212 may be implemented as a private, dedicated network such as, e.g., a Fibre Channel (FC) switching fabric. Alternatively, portions of communication network 212 may be implemented using public communication networks pursuant to a suitable communication protocol such as, e.g., the Internet Small Computer Serial Interface (iSCSI) protocol.

Client computers 214a, 214b, 214c may access storage cells 210a, 210b, 210c through a host, such as servers 216, 220, 230. Clients 214a, 214b, 214c may be connected to file server 216 directly, or via a network 218 such as a Local Area Network (LAN) or a Wide Area Network (WAN). The number of storage cells 210a, 210b, 210c that can be included in any storage network is limited primarily by the connectivity implemented in the communication network 212. A switching fabric comprising a single FC switch can interconnect 256 or more ports, providing a possibility of hundreds of storage cells 210a, 210b, 210c in a single storage network.

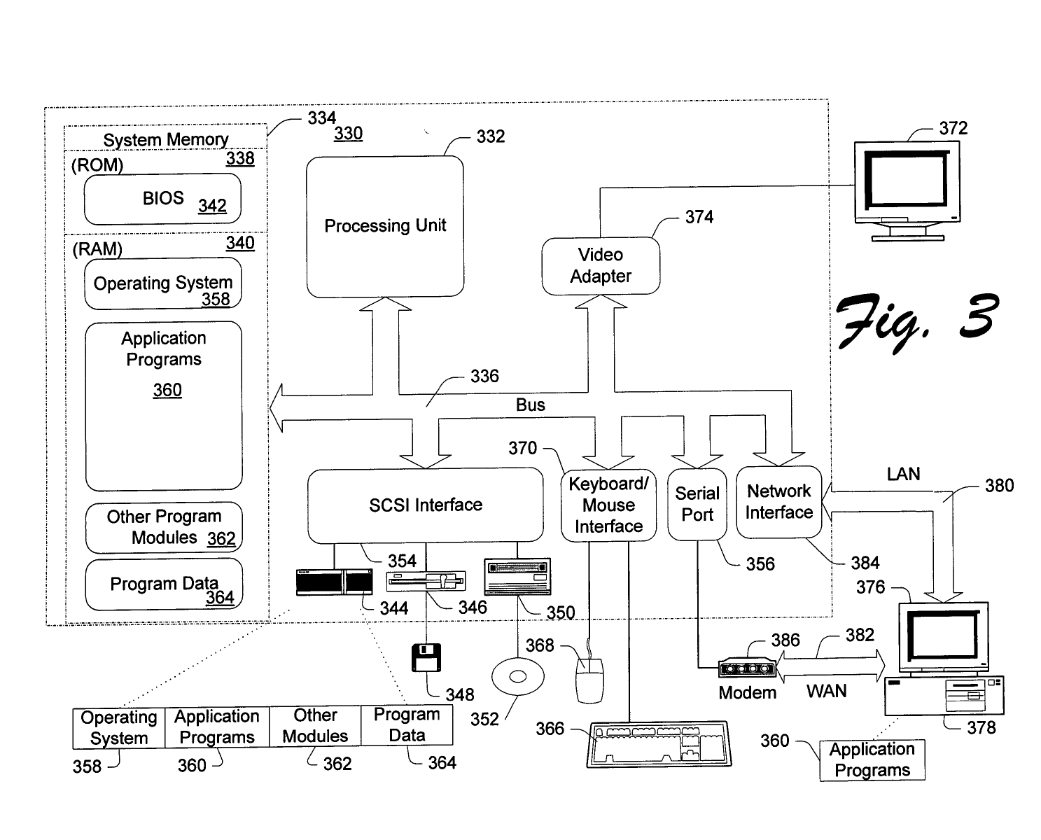

Hundreds or even thousands of host computers 216, 220 may connect to storage network 200 to access data stored in storage cells 210a, 210b, 210c. Hosts 216, 220 may be embodied as server computers. FIG. 3 is a schematic illustration of an exemplary computing device 330 that can be utilized to implement a host. Computing device 330 includes one or more processors or processing units 332, a system memory 334, and a bus 336 that couples various system components including the system memory 334 to processors 332. The bus 336 represents one or more of any of several types of bus structures, including a memory bus or memory controller, a peripheral bus, an accelerated graphics port, and a processor or local bus using any of a variety of bus architectures. The system memory 334 includes read only memory (ROM) 338 and random access memory (RAM) 340. A basic input/output system (BIOS) 342, containing the basic routines that help to transfer information between elements within computing device 330, such as during start-up, is stored in ROM 338.

Computing device 330 further includes a hard disk drive 344 for reading from and writing to a hard disk (not shown), and may include a magnetic disk drive 346 for reading from and writing to a removable magnetic disk 348, and an optical disk drive 350 for reading from or writing to a removable optical disk 352 such as a CD ROM or other optical media. The hard disk drive 344, magnetic disk drive 346, and optical disk drive 350 are connected to the bus 336 by a SCSI interface 354 or some other appropriate interface. The drives and their associated computer-readable media provide nonvolatile storage of computer-readable instructions, data structures, program modules and other data for computing device 330. Although the exemplary environment described herein employs a hard disk, a removable magnetic disk 348 and a removable optical disk 352, other types of computer-readable media such as magnetic cassettes, flash memory cards, digital video disks, random access memories (RAMs), read only memories (ROMs), and the like, may also be used in the exemplary operating environment.

A number of program modules may be stored on the hard disk 344, magnetic disk 348, optical disk 352, ROM 338, or RAM 340, including an operating system 358, one or more application programs 360, other program modules 362, and program data 364. A user may enter commands and information into computing device 330 through input devices such as a keyboard 366 and a pointing device 368. Other input devices (not shown) may include a microphone, joystick, game pad, satellite dish, scanner, or the like. These and other input devices are connected to the processing unit 332 through an interface 370 that is coupled to the bus 336. A monitor 372 or other type of display device is also connected to the bus 336 via an interface, such as a video adapter 374.

Computing device 330 may operate in a networked environment using logical connections to one or more remote computers, such as a remote computer 376. The remote computer 376 may be a personal computer, a server, a router, a network PC, a peer device or other common network node, and typically includes many or all of the elements described above relative to computing device 330, although only a memory storage device 378 has been illustrated in FIG. 3. The logical connections depicted in FIG. 3 include a LAN 380 and a WAN 382.

When used in a LAN networking environment, computing device 330 is connected to the local network 380 through a network interface or adapter 384. When used in a WAN networking environment, computing device 330 typically includes a modem 386 or other means for establishing communications over the wide area network 382, such as the Internet. The modem 386, which may be internal or external, is connected to the bus 336 via a serial port interface 356. In a networked environment, program modules depicted relative to the computing device 330, or portions thereof, may be stored in the remote memory storage device. It will be appreciated that the network connections shown are exemplary and other means of establishing a communications link between the computers may be used.

Hosts 216, 220 may include host adapter hardware and software to enable a connection to communication network 212. The connection to communication network 212 may be through an optical coupling or more conventional conductive cabling depending on the bandwidth requirements. A host adapter may be implemented as a plug-in card on computing device 330. Hosts 216, 220 may implement any number of host adapters to provide as many connections to communication network 212 as the hardware and software support.

Generally, the data processors of computing device 330 are programmed by means of instructions stored at different times in the various computer-readable storage media of the computer. Programs and operating systems distributed, for example, on floppy disks, CD-ROMs, or electronically, and are installed or loaded into the secondary memory of a computer. At execution, the programs are loaded at least partially into the computer's primary electronic memory.

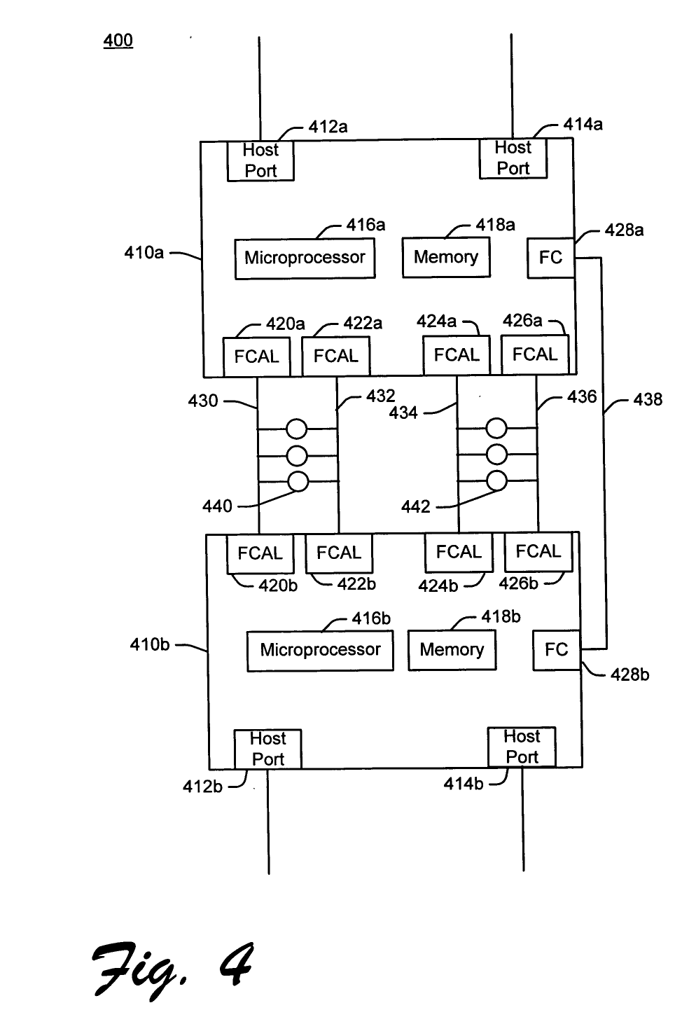

FIG. 4 is a schematic illustration of an exemplary implementation of a storage cell 400, such as storage cell 210. Referring to FIG. 4, storage cell 400 includes two Network Storage Controllers (NSCs), also referred to as disk controllers, 410a, 410b to manage the operations and the transfer of data to and from one or more disk arrays 440, 442. NSCs 410a, 410b may be implemented as plug-in cards having a microprocessor 416a, 416b, and memory 418a, 418b. Each NSC 410a, 410b includes dual host adapter ports 412a, 414a, 412b, 414b that provide an interface to a host, i.e., through a communication network such as a switching fabric. In a Fibre Channel implementation, host adapter ports 412a, 412b, 414a, 414b may be implemented as FC N_Ports. Each host adapter port 412a, 412b, 414a, 414b manages the login and interface with a switching fabric, and is assigned a fabric-unique port ID in the login process. The architecture illustrated in FIG. 4 provides a fully-redundant storage cell; only a single NSC is required to implement a storage cell 210.

Each NSC 410a, 410b further includes a communication port 428a, 428b that enables a communication connection 438 between the NSCs 410a, 410b. The communication connection 438 may be implemented as a FC point-to-point connection, or pursuant to any other suitable communication protocol.

In an exemplary implementation, NSCs 410a, 410b further include a plurality of Fiber Channel Arbitrated Loop (FCAL) ports 420a-426a, 420b-426b that implement an FCAL communication connection with a plurality of storage devices, e.g., arrays of disk drives 440, 442. While the illustrated embodiment implement FCAL connections with the arrays of disk drives 440, 442, it will be understood that the communication connection with arrays of disk drives 440, 442 may be implemented using other communication protocols. For example, rather than an FCAL configuration, a FC switching fabric may be used.

Exemplary Operations

Having described various components of an exemplary storage network, attention is now directed to operations of the storage network 200 and components thereof.

In operation, storage capacity provided by the arrays of disk drives 440, 442 in a storage cells 210a, 210b, 210c may be added to the storage pool 110. When an application requires storage capacity, logic instructions on a host computer 128 may establish a LU from storage capacity available on the arrays of disk drives 440, 442 available in one or more storage cells 210a, 210b, 210c. It will be appreciated that because a LU is a logical unit, not a physical unit, the physical storage space that constitutes the LU may be distributed across multiple storage cells 210a, 210b, 210c. Data for the application may be stored on one or more LUs in the storage network.

An application that needs access to data in the storage network may launch a read query to a host computer. In response to a read query, the host computer queries the NSC(s) on one or more storage cells in which the requested data resides. The NSC(s) retrieve the requested data from the storage media on which it resides and forwards the data to host computer, which in turn can forward data to the requesting device.

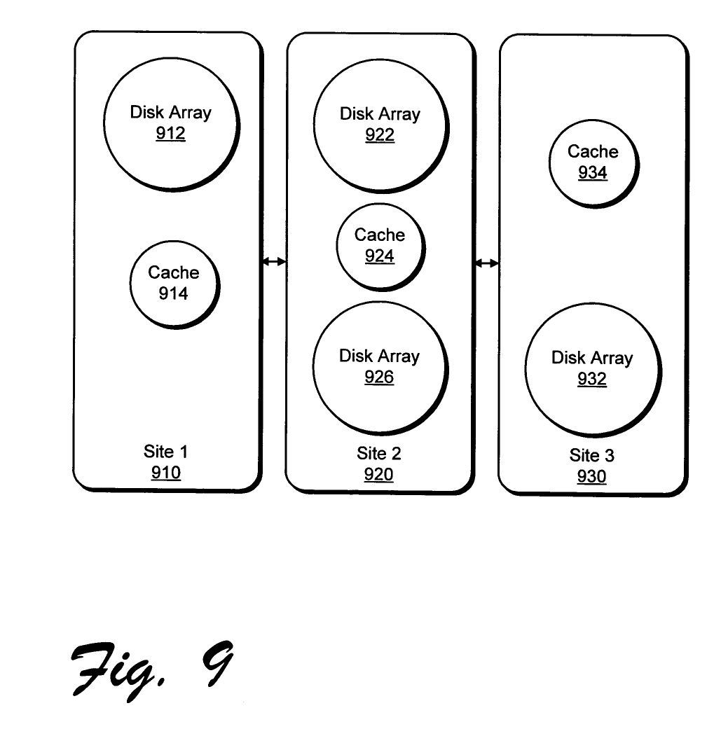

Storage network 200 may implement remote copy procedures to provide data redundancy for data stored in storage cells 210a, 210b, 210c. By way of example, FIG. 9 is a schematic illustration of an exemplary network architecture for three-site data redundancy. Referring to FIG. 9, a LU resident on one or more disk arrays 912 at a first storage site 910 may implement synchronous replication with a remote copy resident on a disk array 922 at a second storage site 920. The second storage site 920 may maintain an internal mirror of disk array 922, e.g., on either the same, or a second disk array 926. The second storage site 920 may implement asynchronous replication with a disk array 932 at a third storage site 930. Referring briefly to FIG. 2, the storage sites 910, 920, and 930 may correspond to the respective storage cells 210a, 210b, and 210c. During the remote copy process the information in the LU is transmitted across the switching fabric, sometimes referred to as a “network cloud” to its destination storage cell.

Write Operations

An application can write data to the storage network 200 by launching a write request to a host computer 216, 220. In response to a write request, a host computer 216, 220 launches a write command to the NSC(s) 410a, 410b in one or more storage cells 210a, 210b, 210c on which the requested data resides. The write command includes the data to be written to the storage network 200. In response to the write command, the NSC(s) 410a, 410b write the data onto the storage media. Referring again to FIG. 9, if the storage network 200 is configured to implement three-site data replication, then data from the write operation is written to a second storage site 920 on the storage network, typically in a synchronous fashion. An internal mirror write operation is performed between a primary copy on the first disk array 922 and a secondary copy which may be on the first disk array 922 or the second disk array 926 at the second site 920. Then the write operation is written from the secondary copy to the third storage site 930.

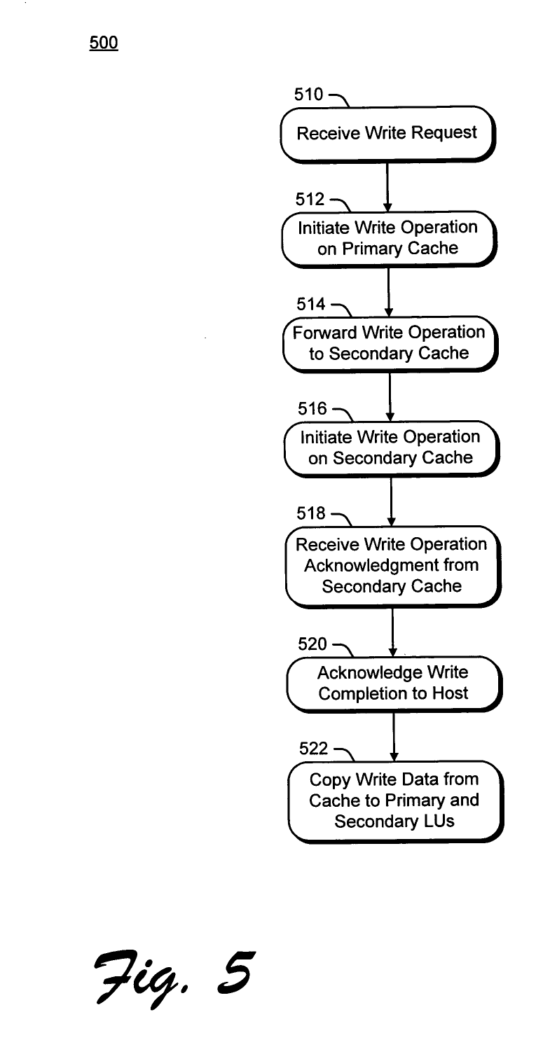

FIGS. 5-8 are flowcharts illustrating exemplary methods for performing internal mirroring operations in a storage array. In exemplary implementations, the methods illustrated in FIGS. 5-8 may be implemented as firmware in a suitable processor such as, e.g., in the storage controller of a storage cell such as the second storage site 920 of a three-site storage architecture. However, the methods illustrated in FIGS. 5-8 may find suitable application in other network architectures.

FIG. 5 is a flowchart illustrating operations 500 in a first exemplary implementation for synchronously executing mirrored write operations on a storage device having a primary and secondary cache. At operation 510 a storage controller receives a write request, e.g., from a host computer over communication network 212. At operation 512 the storage controller initiates a write operation to write the request to the primary cache. At operation 514 the storage controller forwards the write operation to the secondary cache within the same storage device. At operation 516 the storage controller initiates a write operation on the secondary cache within the same storage device. In exemplary implementations write operations are written to the respective caches in an ordered queue that corresponds to the order of execution of the write operations. After the write operation is committed to secondary cache, the storage controller receives a write operation acknowledgment (operation 518) indicating that the write operation is complete. At operation 520 the storage controller sends an acknowledgment to the host computer indicating that the write operation is complete. At operation 522 the storage controller copies the write data from the primary and secondary caches to respective first and second LUs within the same storage device.

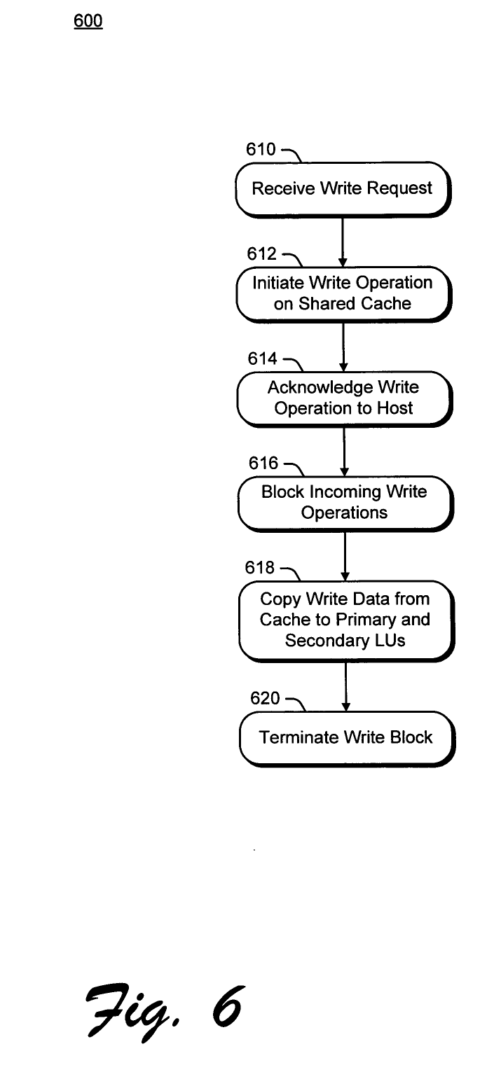

FIG. 6 is a flowchart illustrating operations 600 in a first exemplary implementation for synchronously executing write operations on a storage device having unified (i.e., shared) cache. At operation 610 a storage controller receives a write request, e.g., from a host computer over communication network 212. At operation 612 the storage controller initiates a write operation to write the request to the shared cache. At operation 614 the storage controller sends an acknowledgment to the host computer indicating that the write operation is complete. At operation 616 the storage controller places a block on incoming write operations. At operation 618 the storage controller copies the write data from the primary and secondary caches to respective first and second disk arrays, or LUs. At operation 620 the storage controller terminates the write block, thereby allowing subsequent write requests to be processed by the storage controller.

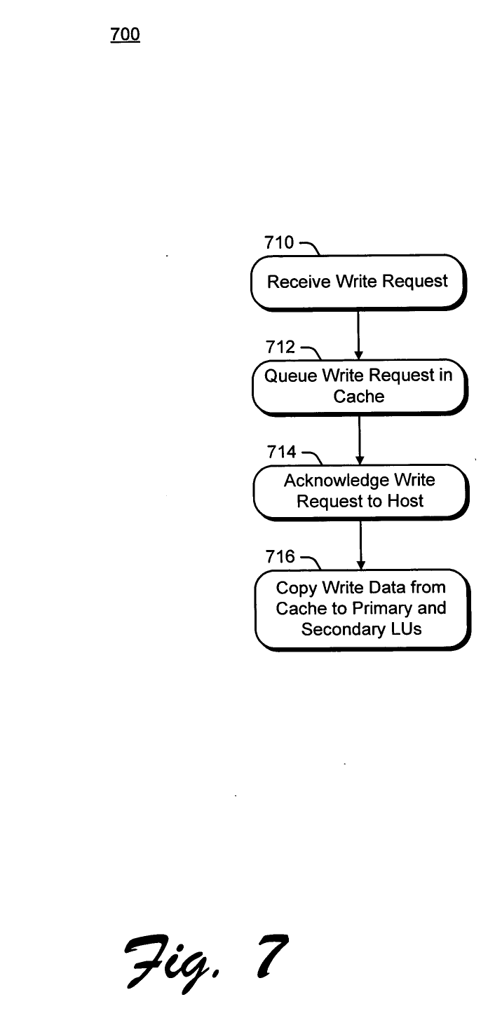

FIG. 7 is a flowchart illustrating operations 700 in a first exemplary implementation for asynchronously executing write operations on a storage device having unified (i.e., shared) cache. At operation 710 a storage controller receives a write request, e.g., from a host computer over communication network 212. At operation 712 the storage controller initiates a write operation to write the request to the shared cache. In exemplary implementations write operations are written to the cache in an ordered queue. At operation 714 the storage controller sends an acknowledgment to the host computer indicating that the write operation is complete. At operation 716 the storage controller copies the write data from the shared cache to respective first and second LUs.

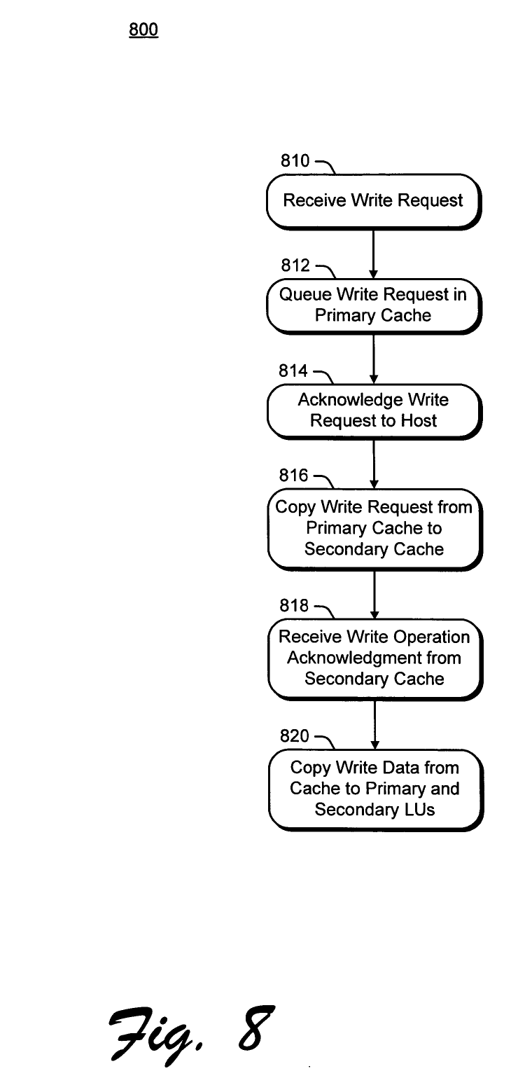

FIG. 8 is a flowchart illustrating operations 800 in a second exemplary implementation for asynchronously executing write operations on a storage device having unified (i.e., shared) cache. At operation 810 a storage controller receives a write request, e.g., from a host computer over communication network 212. At operation 812 the storage controller queues the write request in a primary cache in the storage cell. At operation 814 the storage controller sends an acknowledgment to the host computer indicating that the write operation is complete. At operation 816 the storage controller copies the write request from the primary cache to the secondary cache. After the write operation is committed to secondary cache within the same storage device, the storage controller receives a write operation acknowledgment (operation 818) indicating that the write operation is complete. At operation 820 the storage controller copies the write data from the primary and secondary caches to respective first and second LUs within the same storage device.

In one application, the operations illustrated in FIGS. 5-8 permit a storage cell in the position of the second storage site 920 in a three-site data replication architecture to perform internal data mirroring operations. This enables a fully synchronized three-site data recovery architecture, in which the data set in both the second site and the third site are consistent with the data set on the primary data site. In addition, this permits the internal mirrors within the second data site to be fully data consistent while still consistent with the primary data site.

In another application, the operations of FIGS. 5-8 permit a remote mirror site to contain the secondary copy of an internal pair, while remaining geographically distant from the first storage site. U.S. Patent Application No. 2004/0024838 to Cochran, the disclosure of which is incorporated herein in its entirety, describes network architectures and operations for maintaining dominant and subordinate LUNs in remote copy operations. The operations of FIGS. 5-8 permit a subordinate LUN to maintain a secondary copy of the data as an internal pair. This secondary copy remains data consistent and available for data recovery, if required.

In addition to the specific embodiments explicitly set forth herein, other aspects and embodiments of the present invention will be apparent to those skilled in the art from consideration of the specification disclosed herein. It is intended that the specification and illustrated embodiments be considered as examples only, with a true scope and spirit of the invention being indicated by the following claims.

What is claimed is:

1. A storage network, comprising:
a first storage cell at a first location, the first storage cell including physical storage media and a storage controller that controls data transfer operations with the storage media;
a second storage cell at a second location, the second storage cell including physical storage media and a storage controller that controls data transfer operations with the storage media;
a third storage cell at a third location, the third storage cell including physical storage media and a storage media controller that controls data transfer operations with the storage media;
wherein:
write operations executed on the first storage cell are copied remotely in an ordered sequence to a cache memory in the second storage cell;
write operations in the cache memory are mirrored onto a primary and secondary storage media in the second storage cell; and
write operations mirrored to the secondary storage media are copied remotely to the third storage cell.

2. The storage network of claim 1, wherein the first, second, and third storage cells are geographically distributed.

3. The storage network of claim 1, wherein the second storage cell comprises primary storage media and secondary storage media.

4. The storage network of claim 3, wherein the second storage cell comprises primary cache memory and secondary cache memory.

5. The storage network of claim 1, wherein write operations executed on the first storage cell are copied synchronously to a cache memory in the second storage cell.

6. The storage network of claim 5, wherein write operations copied to a cache memory in the second storage cell are subsequently written to a storage medium.

7. The storage network of claim 6, wherein write operations written to the second storage medium are copied asynchronously to a cache in the third storage cell.

8. The storage network of claim 7, wherein write operations copied to a cache memory in the second storage cell are subsequently written to a storage medium.

9. The storage network of claim 1, wherein write operations from the cache memory are written to the storage medium in the order executed at the first storage site.

10. A method of managing write operations in a storage network, comprising:
executing a write operation at a first storage site in a storage network;
receiving the write request at a storage controller in a second storage site in the storage network;
storing the write request on first storage media in the second storage site; and
mirroring the write request onto a second storage media in the second storage site in an ordered sequence.

11. The method of claim 10, further comprising transmitting the write request to a third storage site in the storage network.

12. The method of claim 10, wherein mirroring the write request onto a second storage media in the second storage site in an ordered sequence comprises synchronously storing the write request in a first cache memory and a second cache memory.

13. The method of claim 12, wherein the storage controller acknowledges completion of the write command after the write request is stored in the first cache memory and the second cache memory.

14. The method of claim 12, further comprising blocking incoming write requests until the storage completes storing the write request in the first cache memory and the second cache memory.

15. The method of claim 10 wherein mirroring the write request onto a second storage media in the second storage site in an ordered sequence comprises copying the write request from the primary and secondary cache onto respective primary and secondary storage media.

16. The method of claim 10, further comprising storing the write request on storage media at the third storage site.

17. A storage controller, comprising:
an input port for receiving write operations from a first remote storage cell;
a processor for executing the write operations; and
an output port for forwarding the write operations to a second remote storage cell,
wherein the processor is configured to store the received write operations in cache memory in an ordered sequence corresponding to the order of execution of the write operations at the first remote storage site.

18. The storage controller of claim 17, wherein the processor is further configured to copy write operations from the cache memory to respective first and second storage media.

19. The storage controller of claim 18, wherein the processor is further configured to transmit write operations executed on the second storage media to a remote storage site.
